(19) United States
(12) Patent Application Publication
(10) Pub. No.: US 2025/0228261 A1
(43) Pub. Date: Jul. 17, 2025

(54) EXTRACTION OF COFFEE OIL FROM COFFEE-BASED FEEDSTOCKS BY USING A GREEN AND SCALABLE NEW PROCESS

(71) Applicant: REVIVE ECO LTD, Newhouse (GB)

(72) Inventors: Ryan TAYLOR, Newhouse (GB); Dawn THOMPSON, Newhouse (GB); Nathan POTTS, Newhouse (GB); Scott KENNEDY, Newhouse (GB); Fergus MOORE, Newhouse (GB)

(21) Appl. No.: 18/700,647

(22) PCT Filed: Oct. 11, 2022
(86) PCT No.: PCT/EP2022/078285

§ 371 Date: Apr. 11, 2024

(30) Foreign Application Priority Data
Oct. 11, 2021 (GB) 2114488.6

(51) Int. Cl. A23F 5/48

(52) U.S. Cl. CPC A23F 5/483

(57) ABSTRACT

Disclosed herein is a process of extracting coffee oil from a coffee-based feedstock by using an extraction solvent, where a mixture of the coffee-based feedstock and the extraction solvent is kept under mechanical or magnetic agitation for at least 30 minutes, and subsequently, a liquid phase including the extraction solvent is separated and the extraction solvent is removed from the liquid phase, to obtain the coffee oil. The extraction solvent can be an ester solvent. Also disclosed herein is a coffee oil obtained by the aforementioned process.

This application is a National Phase entry of International Application No. PCT/EP2022/078285 under § 371 and claims the benefit of GB Patent Application No. 2114488.6, filed Oct. 11, 2021, which is hereby incorporated by reference in its entirety.

### FIELD

The present disclosure relates to a process for extracting coffee oil from coffee-based feedstock and to the coffee oil extracted using said process.

### BACKGROUND

Coffee is one of the most popular beverages in the world, therefore the coffee industry and its consumption has led to large amounts of residues. The growing interest in finding new valuable products from the so-called “residues” has identified “Coffee Oil” as a product that can be used in the cosmetics industry, food industry or biodiesel production and potentially in the pharmaceutical industry.

Coffee oil contains primarily triglycerides, fatty acids, sterols, melanoidins and phospholipids. It is obtained by extraction from different parts of the coffee arabica plant, green or roasted coffee beans, from coffee arabica spent grounds or the like. There is a demand for high quantities of coffee oil for industrial use, thus high yield industrial processes for the extraction of coffee oil are needed. The commonly reported quality parameters for natural oils including coffee arabica oil are acid value, fatty acid composition, iodine value, peroxide value and saponification value.

A widely known method for extracting coffee arabica oil from the spent grounds is by using supercritical fluid extraction. This method typically uses elevated temperatures and pressures to extract the coffee oil with liquefied gases. One of the most common supercritical fluids is CO2. Although the use of CO2 requires less temperature and pressure than other supercritical fluids there are still explosive hazards associated with the scale-up of using supercritical fluid. Build-up of CO2 in enclosed spaces also poses an asphyxia risk to humans.

Another common method of obtaining coffee arabica oil from spent grounds utilizes the Soxhlet extraction. This extraction method requires boiling organic solvent. The condensed vapor then extracts the coffee oil from the coffee grounds. The requirement to heat the organic solvent to reflux for the duration of the process increases costs and decreases energy efficiency of the process.

Further developments evaluated the efficiency of different extraction solvents for coffee extraction and showed hexane as providing the best yield (K. Somnuk, P. Eawlex, G. Prateepchaikul; Agriculture and Natural Resources; Vol 51 (2017); 181-189). Although it produces high yields, hexane is toxic and raises environmental problems, especially used on an industrial scale where large quantities are needed.

Alternative solvents to toxic hexane are disclosed in CN105925364A, where for example solvents including chloroform, acetone, diethyl ether, ethyl acetate, petroleum ether and ethanol are used in an ultrasonic extraction process. The ultrasonic frequency is 30-70 KHZ and the ultrasonic treatment time is 5-40 minutes. The ultrasonic extraction principle is based on the working principle of acoustic or ultrasonic cavitation. However, such a process requires specialized equipment for the production of ultrasound that is not found in ordinary industrial facilities and is expensive. Moreover, the quality of the coffee oil may be affected by the ultrasonic treatment, causing damage to the triglycerides in the coffee oil. For example, there may be observed a degradation of the backbone of the triglyceride in the coffee oil, giving rise to more free fatty acids which could affect the on term stability of the oil.

### SUMMARY

It is thus an aim of embodiments of the present invention to provide a high-yield process for the extraction of high-quality coffee oil, that can be easily applied on an industrial scale using simple, standard industrial equipment and that is simple, cost effective, energy efficient and environmentally friendly. The obtained oil can be further refined, using a simple, cost effective and scalable process to isolate a coffee oil with a low content of undesired components.

At least one embodiment of the invention relates to a process of extracting coffee oil from a coffee-based feedstock by using an extraction solvent, wherein a mixture of the coffee-based feedstock and the extraction solvent is kept under mechanical or magnetic agitation for at least 30 minutes and subsequently a liquid phase comprising the extraction solvent and the extracted coffee oil is separated. Further, the extraction solvent is removed from the liquid phase, to obtain the coffee oil. According to at least one embodiment of the present invention, the extraction solvent is an ester solvent. It has surprisingly been found that, when using ester solvents, a good yield is obtained for the extraction process without the need of heating the solvent. This allows an efficient extraction process that is scalable, easy to use, and resulting in a coffee oil wherein undesired components are avoided, thus requiring less processing and less purification steps.

The process may be performed using standard scale-up equipment and steps like, for example, a large jacketed reactor, mechanical or magnetic agitation and Nutsche filtration. The developed process does not require toxic solvents such as hexane, instead it uses lower toxicity ester solvents which are sustainable and easily scalable.

In a preferred embodiment, the process is conducted at an ambient temperature (circa 15-25° C.).

In another preferred embodiment, freely combinable with the previous ones, the process is conducted for at least 1 hour.

In a further preferred embodiment, freely combinable with the previous ones, the process is conducted at atmospheric pressure.

In a further preferred embodiment, freely combinable with the previous ones, the process is conducted under a standard oxygen rich atmosphere or an inert atmosphere (nitrogen, argon or CO2).

Preferably the ester solvent is selected from the group of aliphatic and aromatic, straight chained and branched acetates, propionates and butyrates.

In a most preferred embodiment the ester solvent is ethyl acetate.

In an additional embodiment, freely combinable with the previous ones, the coffee-based feedstock is selected from roast coffee bean and coffee spent grounds.

In an additional embodiment, freely combinable with the previous ones, the coffee oil further undergoes a process of purification (decolorization and deodorization) to remove undesired components and to obtain a yellow pale to colorless oil. Because the content of undesired components is low, the purification process is very simple, cost effective and easy to scale up.

In a further preferred embodiment, freely combinable with the previous ones, the process of purification comprises the following steps:
dissolving the oil in a suitable solvent, adding activated charcoal to the solution and maintaining the solution under mechanical or magnetic agitation for at least 3 h.
filtering the obtained slurry to separate the liquid phase containing coffee oil;
removing the solvent, preferably in vacuo, to isolate the purified coffee oil.

Suitable solvents are, for example, non-polar organic solvents, preferably heptane.

Further, the process may comprise a step of washing the cake with the solvent and combining the resulting wash with the filtrate before removing the solvent.

At least a further embodiment of the invention relates to a coffee oil comprising triglycerides, fatty acids, sterols, melanoidins and phospholipids, wherein the fatty acid and triglycerides composition is:

| | | |
|---|---|---|
| palmitic acid | 21-87 | peak area % |
| stearic acid | 4-21% | peak area % |
| oleic acid | 4-15% | peak area % |
| linoleic acid | ≤50% | peak area % |
| linolenic acid | ≤2% | peak area % |
| arachidic acid | 1-8% | peak area % |
| behenic acid | ≤3% | peak area %. |

According to a preferred embodiment, the obtained oil has:
optionally, an acid value of 4 mg KOH/g oil or less and/or
optionally, an iodine value of between 13-138 g/100 g and/or
optionally, a SAP value between 132 and 192 and/or
optionally, a peroxide value of 5 mEq oxygen/Kg or less and/or
optionally, a caffeine content of 1.5 wt % or less based on the total weight of the coffee oil and/or
optionally, a tocopherol content of 2 wt % or less based on the total weight of the coffee oil; and/or
optionally, a density between 0-1 g/mL.

The analytical methods are described below.

### BRIEF DESCRIPTION OF THE DRAWINGS

Different aspects and embodiments of the invention will be described in closer detail in the following description of the exemplary embodiments and in the drawings that show:

FIG. 1 shows an overview of the extraction process to obtain coffee oil from waste spent grounds.

FIG. 2 shows a calibration curve obtained from standard solutions of α-tocopherol in a sample of coffee oil, according to at least one embodiment of the present invention.

FIG. 3 shows a calibration curve obtained for the calculation of peroxide value in a sample of coffee oil, according to at least one embodiment of the present invention.

FIG. 4 is a HPLC chromatogram of the standard solution for determination of the caffeine content in a sample of coffee oil, according to at least one embodiment of the present invention.

FIG. 5 is a HPLC chromatogram of a coffee oil sample according to at least one embodiment of the present invention for determination of the caffeine content.

FIG. 6 is a GC chromatogram of a blank sample for determination of fatty acid composition in a sample of coffee oil, according to at least one embodiment of the present invention.

FIG. 7 is a GC chromatogram of the methyl linoleate marker for determination of fatty acid composition in a sample of coffee oil, according to at least one embodiment of the present invention.

FIG. 8 is a GC chromatogram of the fatty acid methyl ester USP Reference Standard mix for determination of fatty acid composition in a sample of coffee oil, according to at least one embodiment of the present invention.

FIG. 9 is a GC chromatogram of a coffee oil sample, according to at least one embodiment of the present invention.

### DETAILED DESCRIPTION

### Coffee-Based Feedstock

According to an embodiment of the present invention, coffee-based feedstock is used as an input material from which coffee oil is extracted. Among preferred examples, the coffee-based feedstock includes roast coffee bean and coffee arabica spent grounds or any other commonly used varieties of coffee available to the public. Roast coffee beans are obtained from green coffee beans that are subjected to a heating process (roasting process). In a preferred embodiment, coffee spent grounds are used, which represent a by-product of the existing coffee industry as the residue obtained during the brewing process and provides a cost-effective and environmentally friendly alternative for the extraction process.

The input material to the developed process will preferably have a moisture content of 10 wt % or below. If the moisture is above 10% then microorganisms such as Botrytis cinerea (common grey mold found on rotting fruit/veg) can begin growing e.g. on the spent grounds, which could lead to the organism(s) producing lipase enzymes, decomposing the triglycerides. Therefore, careful drying to kill organisms may be performed. A moisture meter using IR heating may be used to gravimetrically measure the water content in the input material, for example tracing the mass loss as a function of heating. Alternatively, the same approach may be used with a drying tunnel with an IR probe, as well as IR drying.

### The Extraction Solvent

The extraction of coffee oil is a solid-liquid extraction process, wherein the solid input material as described above is mixed together with a liquid solvent under mechanical agitation to form an extraction mixture. During the process, the coffee oil is leached from the solid input material by the aid of the liquid solvent, also called the extraction solvent. It has been found that when ester solvents are used as the extraction solvent, a sustainable, scalable and cost-effective extraction process is performed.

An ester solvent represents a chemical compound wherein at least a hydroxyl group of a carboxylic acid RCOOH was replaced by an alkoxy group deriving, for example, from an alcohol R′—OH. According to an embodiment of the present invention, the ester solvent is represented by formula (I)

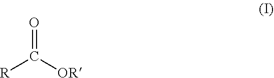

wherein R and R′ represent, independently, a substituted or unsubstituted aliphatic or aromatic group.

Preferably R is an aliphatic group with 1 to 12 carbon atoms.

More preferably, R is a straight or branched chain C1-C4 alkyl group. Even more preferably R, is a straight or branched chain C2-C4 alkyl group. Exemplary R is C1-C4 alkyl groups are, without limiting the scope of embodiments of the invention, methyl, ethyl, propyl, butyl. Such solvents are non-toxic and provide an environmentally friendly alternative for the extraction process.

Preferably R′ is a straight or branched chain alkyl group. More preferably R′ is a C1-C6 alkyl group. Exemplary aromatic groups, without limiting the scope of embodiments of the invention, are phenyl group and benzyl group. Exemplary C1-C6 alkyl groups, without limiting the scope of embodiments of the invention are methyl, ethyl, propyl, butyl, pentyl and hexyl. Even more prepared, R′ is ethyl.

Preferred examples of compounds with formula (I) include methyl acetate, ethyl acetate, n-propyl acetate, isopropyl acetate, n-butyl acetate, t-butyl acetate, benzyl acetate, isoamyl acetate, ethyl phenyl acetate, ethyl propionate or ethyl butyrate.

### Agitation

The extraction process according to an embodiment of the present invention is performed under mechanical and/or magnetic agitation, meaning a process where the solid input material is suspended in the liquid extraction solvent and the mixture remains uniformly suspended by using mechanical and/or magnetic stirring. Mechanical agitation is obtained by using mechanical agitators which transform mechanical power into fluid circulation or agitation. Exemplary agitators include but are not limited to, turbine agitators, paddle agitators, anchor agitators, propeller agitators, helical agitators, etc. Magnetic agitation is achieved by using a magnetized stirrer bar (oval, ellipsed or cross shaped) and an electrical current to cause the stirrer bar to move thus agitating the suspension. Baffles built into the reactor will improve agitation whether magnetic or mechanical. It is thus understood that an ultrasonic treatment of an extraction mixture is not performed under agitation according to an embodiment of the present invention.

### Agitation Time

According to an embodiment of the present invention, the extraction mixture formed of the coffee-based feedstock and the extraction solvent is kept under mechanical or magnetic agitation for at least 30 minutes. If the process is performed for less than 30 minutes then a significant drop in yield is observed.

Preferably, the extraction mixture is kept under mechanical and/or magnetic agitation for a period of at least 30 minutes and at most 24 hours, even more preferably for at least 1 hour and at most 16 hours. If the process is run for more than 24 hours, then the process efficiency decreases as less material can be processed in a given time period.

### Reaction Temperature

Preferably, the extraction process is performed at ambient temperature. By ambient temperature, it is understood to be a temperature of 15-25° C., 59-77° F. or 288.15-298.15 K. Heating above this temperature would be less energy efficient, may lead to transesterification of the triglycerides with the ester solvent (e.g. the fatty acids could be converted to ethyl esters (EEFA)) or to thermal decomposition of the oil.

If the process is performed at <15° C., there is a possibility to observe a drop in the yield of the oil, as solvent capacity may drop with temperature. At the same time, cooling would require consumption of energy and is thus also less energy efficient as maintaining the reaction temperature at ambient temperature.

### Reaction Pressure

Preferably, the extraction process is performed at atmospheric pressure. The term “atmospheric pressure” is defined as 1.01325 bar, 101325 Pa, 1013.25 hPa, 1013.25 mbar, 760 mm Hg, 29.9212 inches of Hg or 14.696 psi. If higher pressure is used in the process, this would require consumption of energy and thus would be less energy efficient. Also, an increased pressure may lead to degradation of the oil.

### Inert Atmosphere

The extraction can be conducted on a small scale under a standard oxygen rich atmosphere. In scale-up facilities, the process is preferably performed under an inert atmosphere to lower the risks due to the flash points of the extraction solvents. By flash point it is understood the lowest temperature at which the extraction solvent can vaporize to form an ignitable mixture in air. The inert atmosphere is obtained by means of an inert gas like, for example, nitrogen or argon. At a larger scale, the extraction will preferably be conducted in a suitable jacketed reactor. The reactor material includes but is not limited to stainless steel, hastelloy, plastic, mild steel and glass. The jacket provides the ability to control the internal temperature irrespective of the temperature outside the reactor.

### Separation of the Oil from the Extraction Solvent

The extraction solvent may be removed from the coffee oil through any method known to the skilled person. For example, the extraction solvent may be removed from the coffee oil under reduced pressure, by using a rotary evaporator or a wiped film evaporator with minimal heating to approximately 60° C.

### Calculation of the Yield of the Obtained Coffee Oil

The yield of the obtained coffee oil is calculated based on the following Formula 1:

$$\frac{Mass of coffee oil output}{Mass of dried spent coffee grounds input} \times 100 \qquad Formula 1$$

wherein the Mass of coffee oil output represents the mass of coffee oil that is weighed after the removal of the solvent and the Mass of dried spent coffee grounds represents the mass of the spent coffee grounds that are mixed with the extracting solvent. If a drying step is performed on the spent coffee grounds to reduce its moisture, then the Mass of spent coffee grounds represents the mass of the dried spent coffee grounds.

### Purification Process

The coffee oil according to an embodiment of the invention may be used as such or may be subjected to a further purification process. The purification may be performed, for example, to obtain decolorization and/or deodorization of the oil or to remove unwanted components. In a preferred application, the unwanted component to be removed are melanoidins. Melanoidins are brown, high molecular weight heterogeneous polymers that are formed when sugars and amino acids combine (through the Maillard Reaction). Melanoidins are responsible for the brown color of the oil. During the roasting process of the coffee beans, melanoidins are further generated such that, in some applications, the content of melanoidins in the coffee oil may be too high for a desired application. The melanoidins precipitate in the oil leading to a biphasic product which is difficult to process in subsequent applications (e.g. lower reproducibility of sampling).

The process of purification comprises the following steps:
dissolving the oil in a suitable solvent and adding activated charcoal to the solution and maintaining the solution under mechanical or magnetic agitation for at least 3 h;
filtering the obtained slurry to separate the liquid phase containing coffee arabica oil;
removing the solvent, preferably in vacuo, to isolate the purified coffee arabica oil.

Suitable solvents are, for example, non-polar organic solvents, preferably heptane.

Optionally, the process comprises a step of washing the cake with the solvent and combining the resulting wash with the filtrate before removing the solvent. Preferably, the washing is performed 2 times.

The purification process can be conducted on filtered or unfiltered obtained coffee oil. For unfiltered coffee oil, the oil first undergoes a process of removing any solid particles present in the oil. Preferably the filtering process is conducted under vacuum. As a non-limiting example, during the filtering process, the oil is passed through a frit 3 sinter funnel under vacuum.

### Calculation of the Content of Undesired Components in the Obtained Coffee Oil

The content of unwanted components (e.g. melanoidins) is calculated based on the following Formula 2:

$$\frac{Mass of native coffee oil - Mass of purified coffee oil}{Mass of native coffee oil} \times 100 \qquad Formula 2$$

wherein the Mass of native coffee oil is the mass of coffee oil which undergoes the purification process, before mixing with the solvent, and Mass of purified coffee arabica oil represents the mass of the oil resulted after evaporation of the solvent used in the purification process.

### Coffee Oil Composition

According to an embodiment of the present invention, by using the extraction process described above, a coffee oil with improved characteristics may be obtained.

Coffee oil or coffee arabica seed oil refers to a primarily lipid oil containing triglycerides, fatty acids, sterols, melanoidins and phospholipids. The coffee arabica seed oil may contain up to 95% triglyceride by NMR.

In a preferred embodiment, the fatty acids composition comprises:

| | | |
|---|---|---|
| palmitic acid | 21-87 | peak area % |
| stearic acid | 4-21% | peak area % |
| oleic acid | 4-15% | peak area % |
| linoleic acid | ≤50% | peak area % |
| linolenic acid | ≤2% | peak area % |
| arachidic acid | 1-8% | peak area % |
| behenic acid | ≤3% | peak area %. |

The method of determination of the peak area % is conducted by cGMP analysis as disclosed in US Pharmacopeia, USP 43-NF38 p.6676 <401> Fixed Fats and Oils. For example, according to the USP, the equation to calculate the individual fatty acid quantity is:

$$Result = \frac{peak area of individual fatty acid}{total peak area of all fatty acids} \times 100$$

An example of method of analysis and calculation is described in the following in the patent application.

The term fatty acids composition as used herein refers to the quantities of the different fatty acids present in the product of coffee oil hydrolysis and includes both the free fatty acids and the bound fatty acids in the triglycerides, all being present in the coffee oil. The fatty acid composition is recorded as percentage peak area obtained from integrated signals in the chromatogram produced from gas chromatography.

According to a preferred embodiment of the present invention, a coffee oil with a peroxide value of 5 mEq Oxygen/g or less may be obtained. The term peroxide value refers to a measure of oxidation present in the oil. If this value is elevated, this is an indication of radical decomposition/oxidation.

According to another preferred embodiment freely combinable with the above one, a coffee oil with an iodine value of 130 g/100 g of oil or less may be obtained. The term iodine value refers to a measure of unsaturation of the oil and is measured as grams of iodine consumed per 100 g of oil (g/100 g).

According to yet another preferred embodiment freely combinable with any of the above embodiments, a coffee oil with an acid value of 3 mg KOH/g or less may be obtained. The term acid value (or free fatty acids) refers to the quantity of potassium hydroxide required to neutralize the free fatty acids present in the oil. Free fatty acid or acid value is measured in milligrams of potassium hydroxide per 1 gram of oil (mg/g). The acid value indicates the level of unbound fatty acids present in the oil, varying levels potentially affecting the pH and the quality of the oil.

According to yet another preferred embodiment freely combinable with any of the above embodiments, a coffee oil with a saponification value of 140 mg/g or more and 185 mg/g or less may be obtained. The term saponification value refers to the quantity of potassium hydroxide required to neutralize the free fatty acids present in the oil and saponify the esters in 1 g of oil. The saponification value is measured in milligrams of potassium hydroxide per 1 gram of oil (mg/g). The saponification value indicates the quantity of total fatty acids, bound as esters in the triglyceride and unbound free fatty acids, present in the oil.

According to yet another preferred embodiment freely combinable with any of the above embodiments, a coffee oil with a caffeine content of 1.5 wt % based on the total weight of the coffee oil or less may be obtained.

According to yet another preferred embodiment freely combinable with any of the above embodiments, a coffee oil with a tocopherol content of 2 wt % based on the total weight of the coffee oil or less may be obtained.

According to yet another preferred embodiment freely combinable with any of the above embodiments, a coffee oil with a density of 0.861g/mL or less and 0.989 g/mL or more may be obtained. The term density refers to the mass per unit volume of the oil and shows the lipophilic character of the oil as oils are less dense than water.

### <EXAMPLES>EXAMPLES

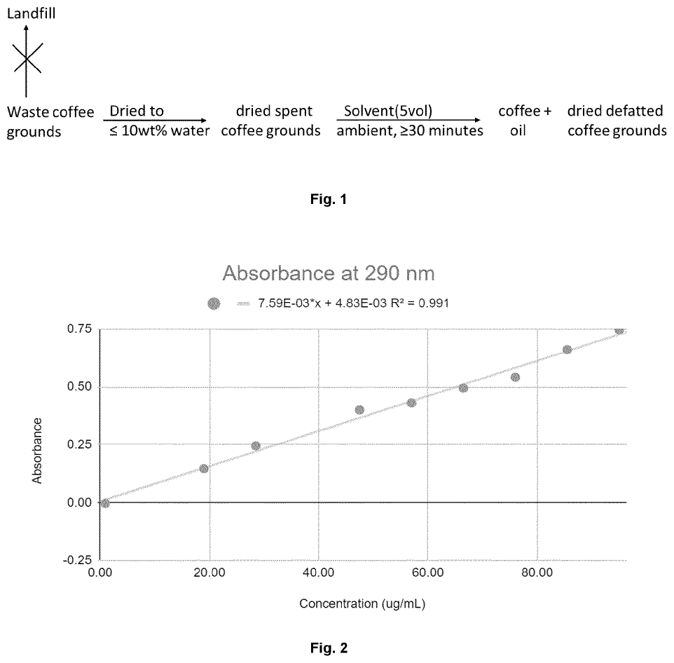

An exemplary embodiment of the extraction process to obtain coffee oil from waste spent grounds will be described in detail below with reference to the drawings. FIG. 1 shows an overview of the extraction process to obtain coffee oil from waste spent grounds which would otherwise be sent to landfill. The process may be equally applicable to any other type of input material, that is of coffee-based feedstock as described in an embodiment of the present invention. First, the waste coffee grounds are dried until the moisture content is ≤10 wt %. The dried spent coffee grounds are mixed with the extraction solvent according to an embodiment of the present invention at ambient temperature and atmospheric pressure and kept for at least 30 minutes under mechanical and/or magnetic agitation. The coffee grounds are filtered off and the filtrate is concentrated in vacuo, to obtain brown coffee arabica oil.

The starting materials were furnished by different local café shops.

Spent coffee grounds used in all extractions are a mixture of different cafés waste coffee grounds. Each batch was mixed before use to ensure homogenous content.

Virgin beans (dark roast) were collected from one of these cafes. The beans were grounded using an “UUOUU Mini Grinder” and passed through a sieve to remove any unground beans. The sieved product was used in the extraction process for a direct comparison with extraction of spent coffee grounds.

### Process of Extracting the Coffee Oil with Different Solvents—Laboratory Scale Experiments

Examples 1 to 11, 21 to 24 and Comparative example 1 were performed using the same batch of spent coffee grounds obtained from a local café.

### Example 1

Spent coffee grounds (limiting reagent; LR, 10.07 g) were agitated with methyl acetate (50 mL; 5 vol) for 16 hr at ambient temperature and atmospheric pressure in a 100 mL round bottomed flask. The coffee grounds were filtered and the cake was washed twice with methyl acetate (10.07 mL; 1 vol). The filtrate was concentrated in vacuo to obtain 1.31 g of brown coffee arabica oil (13.1% yield).

Calculation of the yield is made based on Formula 1:

$$\frac{Mass of coffee oil output}{Mass of dried spent coffee grounds input} \times 100 = \frac{1.31}{10.07} \times 100 = 13.1 \% \qquad Formula 1$$

### Example 2

In the same way as in Example 1, spent coffee grounds (limiting reagent; LR) were agitated with ethyl acetate (5 vol) for 16 hr at ambient temperature and atmospheric pressure, to obtain the brown coffee arabica oil (14.1% yield).

### Example 3

In the same way as in Example 1, spent coffee grounds (limiting reagent; LR) were agitated with n-propyl acetate (5 vol) for 16 hr at ambient temperature and atmospheric pressure, to obtain the brown coffee arabica oil (14.3% yield).

### Example 4

In the same way as in Example 1, spent coffee grounds (limiting reagent; LR) were agitated with isopropyl acetate (5 vol) for 16 hr at ambient temperature and atmospheric pressure, to obtain the brown coffee arabica oil (14.4% yield).

### Example 5

In the same way as in Example 1, spent coffee grounds (limiting reagent; LR) were agitated with tert-butyl acetate (5 vol) for 16 hr at ambient temperature and atmospheric pressure, to obtain the brown coffee arabica oil (16.4% yield).

### Example 6

In the same way as in Example 1, spent coffee grounds (limiting reagent; LR) were agitated with n-butyl acetate (5 vol) for 16 hr at ambient temperature and atmospheric pressure, to obtain the brown coffee arabica oil (14.2% yield).

### Example 7

In the same way as in Example 1, spent coffee grounds (limiting reagent; LR) were agitated with isoamyl acetate (5 vol) for 16 hr at ambient temperature and atmospheric pressure to obtain the brown coffee arabica oil (13.1% yield).

### Example 8

In the same way as in Example 1, spent coffee grounds (limiting reagent; LR) were agitated with ethyl propionate (5 vol) for 16 hr at ambient temperature and atmospheric pressure, to obtain the brown coffee arabica oil (13.1% yield).

### Example 9

In the same way as in Example 1, spent coffee grounds (limiting reagent; LR) were agitated with ethyl butyrate (5 vol) for 16 hr at ambient temperature and atmospheric pressure, to obtain the brown coffee arabica oil (13.2% yield).

### Example 10

In the same way as in Example 1, spent coffee grounds (limiting reagent; LR) were agitated with benzyl acetate (5 vol) for 16 hr at ambient temperature and atmospheric pressure in a 100 mL round bottomed flask. The coffee grounds were filtered and the cake was washed twice with benzyl acetate (1 vol). A brown solution was obtained, similar in color to the oil of all the preceding Examples. The oil could not be isolated due to low volatility of the organic solvent used. The solution was analyzed for fatty acid composition and the results were similar to the preceding Examples.

### Example 11

In the same way as in Example 1, spent coffee grounds (limiting reagent; LR) were agitated with ethyl phenyl acetate (5 vol) for 16 hr at ambient temperature and atmospheric pressure, in a 100 mL round bottomed flask. The coffee grounds were filtered and the cake was washed twice with ethyl phenyl acetate (1 vol). A brown solution was obtained, similar in color to the oil of all the preceding Examples. The oil could not be isolated due to low volatility of the organic solvent used. The solution was analyzed for fatty acid composition and the results were similar to the preceding Examples.

### Comparative Example 1

Spent coffee grounds (limiting reagent; LR, 10.02 g) were agitated with hexane (50 ml; 5 vol) for 16 hr at ambient temperature and atmospheric pressure in a 100 mL round bottomed flask. The coffee grounds were filtered and the cake was washed twice with hexane (10 mL; 1 vol). The filtrate was concentrated in vacuo to obtain 1.23 g of brown coffee arabica oil (12.3% yield).

Calculation of the yield is made based on Formula 1:

$$\frac{Mass of coffee oil output}{Mass of dried spent coffee grounds input} \times 100 = \frac{1.23}{10.02} \times 100 = 12.3 \%$$

The results from these examples are summarized in Table 1.

TABLE 1
Yields observed during extraction of coffee oil from
dried spent coffee grounds using various solvents

| | | Time | Yield |
|---|---|---|---|
| Example No. | Solvent | (hours) | (%) |
| Example 1 | methyl acetate | 16 | 13.1 |
| Example 2 | ethyl acetate | 16 | 14.1 |
| Example 3 | n-propyl acetate | 16 | 14.3 |
| Example 4 | isopropyl acetate | 16 | 14.4 |
| Example 5 | tert-butyl acetate | 16 | 16.4 |
| Example 6 | n-butyl acetate | 16 | 14.2 |
| Example 7 | isoamyl acetate | 16 | 13.1 |
| Example 8 | ethyl propionate | 16 | 13.1 |
| Example 9 | ethyl butyrate | 16 | 13.2 |
| Example 10 | benzyl acetate | 16 | not isolated* |
| Example 11 | ethyl phenyl acetate | 16 | not isolated* |
| Comparative | Hexane | 16 | 12.3 |
| example 1 | | | |

*oil not isolated due to low volatility of the organic solvent used.

From Table 1, it can be observed that using hexane as an extraction solvent is both less environmentally friendly and less efficient, with a yield clearly below the ones obtained by using an extraction solvent according to an embodiment of the present invention.

### Process of Extracting the Coffee Oil; Yield Assessment Over Time

Next, the evolution of the yield in time is observed when extracting coffee oil from dried spent coffee grounds using ethyl acetate as an extraction solvent, at ambient temperature and atmospheric pressure. The results are summarized in Table 2.

### Example 21

Spent coffee grounds (60.87 g; limiting reagent; LR) were agitated with ethyl acetate (300 mL; 5 vol) for 30 minutes at ambient temperature and atmospheric pressure in a 500 mL round bottomed flask. The coffee grounds were filtered and the cake was washed twice with ethyl acetate (60 mL; 1 vol). The filtrate was concentrated in vacuo to obtain the brown coffee arabica oil (13.4% yield).

### Example 22

In the same way as in Example 21, spent coffee grounds were agitated with ethyl acetate, but for 1 hour at ambient temperature and atmospheric pressure, to obtain the brown coffee arabica oil (13.0% yield).

### Example 23

In the same way as in Example 21, spent coffee grounds were agitated with ethyl acetate, but for 6 hr at ambient temperature and atmospheric pressure, to obtain the brown coffee arabica oil (13.6% yield).

### Example 24

In the same way as in Example 21, spent coffee grounds were agitated with ethyl acetate, but for 48 hr at ambient temperature and atmospheric pressure, to obtain the brown coffee arabica oil (14.0% yield).

The results are summarized in Table 2.

TABLE 2
Yields observed during extraction of coffee oil from dried spent coffee
grounds when varying the extraction times with ethyl acetate.

| Example no. | Solvent | Time (hours) | | Yield (%) |
|---|---|---|---|---|
| Example 21 | ethyl acetate | 0.5 | hours | 13.4 |
| Example 22 | ethyl acetate | 1 | hour | 13.5 |
| Example 23 | ethyl acetate | 6 | hours | 13.6 |
| Example 2 | ethyl acetate | 16 | hours | 14.1 |
| Example 24 | ethyl acetate | 48 | hours | 14.0 |

From Table 2, it can be observed that the yield after 16 hours remains similar in values. As the yields from 16-48 h are similar, the energy required to keep the process running for the additional time is not justified and the process becomes inefficient.

### Process of Re-Extracting the Coffee Oil from Defatted Spent Coffee Grounds

### Example 31

Spent coffee grounds extracted with ethyl acetate as per Example 22 were subsequently dried to ≤10% and were re-extracted with ethyl acetate. Dried defatted spent coffee grounds (60.42 g; LR) were agitated with ethyl acetate (300 mL; 5 vol) for 16 hours at ambient temperature and atmospheric pressure in a 500 mL round bottomed flask. The coffee grounds were filtered, and the cake was washed twice with ethyl acetate (60 mL; 1 vol). The filtrate was concentrated in vacuo to obtain the brown coffee arabica oil (1.17 g; 1.9% yield). As can be seen, the amount of coffee oil recovered after re-extraction is very low, meaning that an efficient process is performed in the first extraction according to an embodiment of the present invention.

### Scale-Up Experiments

Examples 41-42 were performed using another batch of spent coffee grounds obtained from a local café. A 20 L glass jacketed reactor was used for extraction process.

### Example 41

Spent coffee grounds (2 kg; limiting reagent; LR) were agitated in ethyl acetate (10 L; 5 vol) for 1 hour at ambient temperature and atmospheric pressure in a 20 L glass jacketed reactor. The coffee grounds were filtered through a sintered funnel (frit 3). The reactor and cake were washed with ethyl acetate (2 L; 1 vol). The cake was washed with a further portion of ethyl acetate (2 L; 1 vol). The solvent was removed via distillation from the reactor at atmospheric pressure and elevated temperature. The final concentration was completed in vacuo in a rotary evaporator to yield brown native coffee arabica oil (235 g; 11.8%).

### Example 42

Spent coffee grounds (2 kg; limiting reagent; LR) were agitated in ethyl acetate (10 L; 5 vol) for 2 hours at ambient temperature and atmospheric pressure in a 20 L glass jacketed reactor. The coffee grounds were filtered through a sintered funnel (frit 3). The reactor and cake were washed with ethyl acetate (2 L; 1 vol). The cake was washed with a further portion of ethyl acetate (2 L; 1 vol). The solvent was removed via distillation from the reactor at atmospheric pressure and elevated temperature. The final concentration was completed in vacuo in a rotary evaporator to yield brown native coffee arabica oil (226 g; 12.7%).

### Content of Undesired Components (e.g. Melanoidins)

Spent coffee grounds from the same batch were extracted with ethyl acetate for 1 hr at ambient temperature and atmospheric pressure and for 1 hr at reflux. The resulted coffee oil was used in the following experiments.

### Example 51

Coffee arabica oil obtained by extraction with ethyl acetate for 1 hr at ambient temperature and atmospheric pressure (16.34 g; LR) was dissolved in heptane (65 mL; 4 vol). The solution of coffee oil in heptane was added to a 500 mL flask containing activated carbon (12.35 g; 75 wt %). The flask was rinsed with heptane (16 mL; 1 vol) and the wash was added to the flask containing charcoal, heptane and oil. The slurry was agitated for 3 h at ambient temperature and atmospheric pressure. The slurry was filtered. The flask and cake were washed twice with heptane (16 mL; 1 vol). The cake only was washed twice more with heptane (16 mL; 1 vol). The combined filtrate and washes were concentrated in vacuo to obtain a yellow decolorized and deodorized coffee arabica oil (13.99 g; 85.6%). Mass loss during the decolorization for ambient extracted native coffee arabica oil is 2.35 g (14.4%).

### Example 52

Coffee arabica oil obtained by extraction with ethyl acetate for 1 hr at reflux (17.88 g; LR) was dissolved in heptane (71 mL; 4 vol). The solution of coffee oil in heptane was added to a 500 mL flask containing activated carbon (13.43 g; 75 wt %). The flask was rinsed with heptane (18 mL; 1 vol) and the wash was added to the flask containing charcoal, heptane, and oil. The slurry was agitated for 3 h at ambient temperature and atmospheric pressure. The slurry was filtered. The flask and cake were washed twice with heptane (18 mL; 1 vol). The cake only was washed twice more with heptane (18 mL; 1 vol). The combined filtrate and washes were concentrated in vacuo to obtain a yellow decolorized and deodorized coffee arabica oil (14.64 g; 81.9%). Mass loss during the decolorization for ambient extracted native coffee arabica oil is 3.24 g (18.1%).

The result showed that the coffee oil obtained by extraction with ethyl acetate at reflux had a higher content of melanoidins than the coffee oil obtained by extraction with ethyl acetate at ambient temperature and atmospheric pressure.

### Extractions Using Different Esters

The following examples were made using spent coffee grounds from the same batch.

### Example 61

To a 100 mL round bottomed flask was added spent coffee grounds (10.07 g; LR) and methyl acetate (50 mL; 5 vol). The slurry was agitated for 16 hr at ambient temperature and atmospheric pressure. The slurry was filtered through a sintered funnel (Frit 3). The flask and cake were washed with methyl acetate (10 mL; 1 vol). The cake only was washed with a further portion of methyl acetate (10 mL; 1 vol). The combined filtrate and washes were concentrated in vacuo at 45-50° C. The product isolated was a dark orange oil (1.37 g; 13.6% yield).

### Example 62

To a 100 mL round bottomed flask was added spent coffee grounds (10.06 g; LR) and methyl acetate (50 mL; 5 vol). The slurry was agitated for 1 hr at ambient temperature and atmospheric pressure. The slurry was filtered through a sintered funnel (Frit 3). The flask and cake were washed with methyl acetate (10 mL; 1 vol). The cake only was washed with a further portion of methyl acetate (10 mL; 1 vol). The combined filtrate and washes were concentrated in vacuo at 45-50° C. The product isolated was a dark orange oil (1.02 g; 10.1% yield).

### Comparative Example 2

To a 100 mL round bottomed flask was added spent coffee grounds (10.04 g; LR) and methyl acetate (50 mL; 5 vol). The slurry was agitated for 1 hr at reflux. The contents were allowed to cool to ambient temperature. The slurry was filtered through a sintered funnel (Frit 3). The flask and cake were washed with methyl acetate (10 mL; 1 vol). The cake only was washed with a further portion of methyl acetate (10 mL; 1 vol). The combined filtrate and washes were concentrated in vacuo at 45-50° C. The product isolated was a brown oil with dark brown/black solid precipitate present (1.05 g; 10.5% yield).

### Example 63

To a 100 mL round bottomed flask was added spent coffee grounds (10.02 g; LR) and n-propyl acetate (50 mL; 5 vol). The slurry was agitated for 16 hr at ambient temperature and atmospheric pressure. The slurry was filtered through a sintered funnel (Frit 3). The flask and cake were washed with n-propyl acetate (10 mL; 1 vol). The cake only was washed with a further portion of n-propyl acetate (10 mL; 1 vol). The combined filtrate and washes were concentrated in vacuo at 45-50° C. The product isolated was a dark orange oil (1.23 g; 12.3% yield).

### Example 64

To a 100 mL round bottomed flask was added spent coffee grounds (10.04 g; LR) and n-propyl acetate (50 mL; 5 vol). The slurry was agitated for 1 hr at ambient temperature and atmospheric pressure. The slurry was filtered through a sintered funnel (Frit 3). The flask and cake were washed with n-propyl acetate (10 mL; 1 vol). The cake only was washed with a further portion of n-propyl acetate (10 mL; 1 vol). The combined filtrate and washes were concentrated in vacuo at 45-50° C. The product isolated was a dark orange oil (1.03 g; 10.3% yield).

### Comparative Example 3

To a 100 mL round bottomed flask was added spent coffee grounds (10.08 g; LR) and n-propyl acetate (50 mL; 5 vol). The slurry was agitated for 1 hr at reflux. The contents were allowed to cool to ambient temperature. The slurry was filtered through a sintered funnel (Frit 3). The flask and cake were washed with n-propyl acetate (10 mL; 1 vol). The cake only was washed with a further portion of n-propyl acetate (10 mL; 1 vol). The combined filtrate and washes were concentrated in vacuo at 45-50° C. The product isolated was a brown oil with brown solid precipitate present (1.23 g; 12.2% yield).

### Example 65

To a 100 mL round bottomed flask was added spent coffee grounds (10.08 g; LR) and isopropyl acetate (50 mL; 5 vol). The slurry was agitated for 16 hr at ambient temperature and atmospheric pressure. The slurry was filtered through a sintered funnel (Frit 3). The flask and cake were washed with isopropyl acetate (10 mL; 1 vol). The cake only was washed with a further portion of isopropyl acetate (10 mL; 1 vol). The combined filtrate and washes were concentrated in vacuo at 45-50° C. The product isolated was a dark orange oil (1.29 g; 12.8% yield).

### Example 66

To a 100 mL round bottomed flask was added spent coffee grounds (10.05 g; LR) and isopropyl acetate (50 mL; 5 vol). The slurry was agitated for 1 hr at ambient temperature and atmospheric pressure. The slurry was filtered through a sintered funnel (Frit 3). The flask and cake were washed with isopropyl acetate (10 mL; 1 vol). The cake only was washed with a further portion of isopropyl acetate (10 mL; 1 vol). The combined filtrate and washes were concentrated in vacuo at 45-50° C. The product isolated was a dark orange oil (1.11 g; 11.0% yield).

### Comparative Example 4

To a 100 mL round bottomed flask was added spent coffee grounds (10.07 g; LR) and isopropyl acetate (50 mL; 5 vol). The slurry was agitated for 1 hr at reflux. The contents were allowed to cool to ambient temperature. The slurry was filtered through a sintered funnel (Frit 3). The flask and cake were washed with isopropyl acetate (10 mL; 1 vol). The cake only was washed with a further portion of isopropyl acetate (10 mL; 1 vol). The combined filtrate and washes were concentrated in vacuo at 45-50° C. The product isolated was a brown oil with dark brown/black solid precipitate present (1.22 g; 12.1% yield).

### Example 67

To a 100 mL round bottomed flask was added spent coffee grounds (10.05 g; LR) and n-butyl acetate (50 mL; 5 vol). The slurry was agitated for 16 hr at ambient temperature and atmospheric pressure. The slurry was filtered through a sintered funnel (Frit 3). The flask and cake were washed with n-butyl acetate (10 mL; 1 vol). The cake only was washed with a further portion of n-butyl acetate (10 mL; 1 vol). The combined filtrate and washes were concentrated in vacuo at 45-50° C. The product isolated was a dark orange-brown oil (1.25 g; 12.4% yield).

### Example 68

To a 100 mL round bottomed flask was added spent coffee grounds (10.00 g; LR) and n-butyl acetate (50 mL; 5 vol). The slurry was agitated for 1 hr at ambient temperature and atmospheric pressure. The slurry was filtered through a sintered funnel (Frit 3). The flask and cake were washed with n-butyl acetate (10 mL; 1 vol). The cake only was washed with a further portion of n-butyl acetate (10 mL; 1 vol). The combined filtrate and washes were concentrated in vacuo at 45-50° C. The product isolated was a dark orange oil (1.02 g; 10.2% yield).

### Comparative Example 5

To a 100 mL round bottomed flask was added spent coffee grounds (10.04 g; LR) and n-butyl acetate (50 mL; 5 vol). The slurry was agitated for 1 hr at reflux. The contents were allowed to cool to ambient temperature. The slurry was filtered through a sintered funnel (Frit 3). The flask and cake were washed with n-butyl acetate (10 mL; 1 vol). The cake only was washed with a further portion of n-butyl acetate (10 mL; 1 vol). The combined filtrate and washes were concentrated in vacuo at 45-50° C. The product isolated was a brown oil with solid precipitate present (1.25 g; 12.5% yield).

### Example 69

To a 100 mL round bottomed flask was added spent coffee grounds (10.04 g; LR) and t-butyl acetate (50 mL; 5 vol). The slurry was agitated for 16 hr at ambient temperature and atmospheric pressure. The slurry was filtered through a sintered funnel (Frit 3). The flask and cake were washed with t-butyl acetate (10 mL; 1 vol). The cake only was washed with a further portion of t-butyl acetate (10 mL; 1 vol). The combined filtrate and washes were concentrated in vacuo at 45-50° C. The product isolated was a dark orange oil (1.14 g; 11.4% yield).

### Example 70

To a 100 mL round bottomed flask was added spent coffee grounds (10.03 g; LR) and t-butyl acetate (50 mL; 5 vol). The slurry was agitated for 1 hr at ambient temperature and atmospheric pressure. The slurry was filtered through a sintered funnel (Frit 3). The flask and cake were washed with t-butyl acetate (10 mL; 1 vol). The cake only was washed with a further portion of t-butyl acetate (10 mL; 1 vol). The combined filtrate and washes were concentrated in vacuo at 45-50° C. The product isolated was a dark orange oil (1.00 g; 10.0% yield).

### Comparative Example 6

To a 100 mL round bottomed flask was added spent coffee grounds (10.07 g; LR) and t-butyl acetate (50 mL; 5 vol). The slurry was agitated for 1 hr at reflux. The contents were allowed to cool to ambient temperature. The slurry was filtered through a sintered funnel (Frit 3). The flask and cake were washed with t-butyl acetate (10 mL; 1 vol). The cake only was washed with a further portion of t-butyl acetate (10 mL; 1 vol). The combined filtrate and washes were concentrated in vacuo at 45-50° C. The product isolated was a brown oil with brown-black precipitate (1.17 g; 11.6% yield).

### Example 71

To a 100 mL round bottomed flask was added spent coffee grounds (10.06 g; LR) and benzyl acetate (50 mL; 5 vol). The slurry was agitated for 16 hr at ambient temperature and atmospheric pressure. The slurry was filtered through a sintered funnel (Frit 3). The flask and cake were washed with benzyl acetate (10 mL; 1 vol). The cake only was washed with a further portion of benzyl acetate (10 mL; 1 vol). Due to the low volatility of the solvent, the product could not be isolated however the solution obtained was analyzed for appearance. The solution obtained was a light brown-yellow clear solution.

### Example 72

To a 100 mL round bottomed flask was added spent coffee grounds (10.05 g; LR) and benzyl acetate (50 mL; 5 vol). The slurry was agitated for 1 hr at ambient temperature and atmospheric pressure. The slurry was filtered through a sintered funnel (Frit 3). The flask and cake were washed with benzyl acetate (10 mL; 1 vol). The cake only was washed with a further portion of benzyl acetate (10 mL; 1 vol). Due to the low volatility of the solvent, the product could not be isolated however the solution obtained was analyzed for appearance. The solution obtained was a light brown-yellow clear solution.

### Comparative Example 7

To a 100 mL round bottomed flask was added spent coffee grounds (10.08 g; LR) and benzyl acetate (50 mL; 5 vol). The slurry was agitated for 1 hr at reflux. The contents were allowed to cool to ambient temperature. The slurry was filtered through a sintered funnel (Frit 3). The flask and cake were washed with benzyl acetate (10 mL; 1 vol). The cake only was washed with a further portion of benzyl acetate (10 mL; 1 vol). Due to the low volatility of the solvent, the product could not be isolated however the solution obtained was analyzed for appearance. The solution obtained was a dark brown clear solution.

### Example 73

To a 100 mL round bottomed flask was added spent coffee grounds (10.07 g; LR) and ethyl acetate (50 mL; 5 vol). The slurry was agitated for 16 hr at ambient temperature and atmospheric pressure. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a dark orange-brown oil (1.19 g; 11.8% yield).

### Example 74

To a 100 mL round bottomed flask was added spent coffee grounds (10.05 g; LR) and ethyl acetate (50 mL; 5 vol). The slurry was agitated for 1 hr at ambient temperature and atmospheric pressure. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a dark orange-brown oil (1.04 g; 10.3% yield).

### Comparative Example 8

To a 100 mL round bottomed flask was added spent coffee grounds (10.09 g; LR) and ethyl acetate (50 mL; 5 vol). The slurry was agitated for 1 hr at reflux. The contents were allowed to cool to ambient temperature. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a dark brown oil with solid precipitate present (1.13 g; 11.2% yield).

### Example 75

To a 100 mL round bottomed flask was added spent coffee grounds (10.01 g; LR) and ethyl phenyl acetate (50 mL; 5 vol). The slurry was agitated for 16 hr at ambient temperature and atmospheric pressure. The slurry was filtered through a sintered funnel (Frit 3). The flask and cake were washed with ethyl phenyl acetate (10 mL; 1 vol). The cake only was washed with a further portion of ethyl phenyl acetate (10 mL; 1 vol). Due to the low volatility of the solvent, the product could not be isolated however the solution obtained was analyzed for appearance. The solution obtained was a light brown-yellow clear solution.

### Example 76

To a 100 mL round bottomed flask was added spent coffee grounds (10.03 g; LR) and ethyl phenyl acetate (50 mL; 5 vol). The slurry was agitated for 1 hr at ambient temperature and atmospheric pressure. The slurry was filtered through a sintered funnel (Frit 3). The flask and cake were washed with ethyl phenyl acetate (10 mL; 1 vol). The cake only was washed with a further portion of ethyl phenyl acetate (10 mL; 1 vol). Due to the low volatility of the solvent, the product could not be isolated however the solution obtained was analyzed for appearance. The solution obtained was a light brown-yellow clear solution.

### Comparative Example 9

To a 100 mL round bottomed flask was added spent coffee grounds (10.03 g; LR) and ethyl phenyl acetate (50 mL; 5 vol). The slurry was agitated for 1 hr at reflux. The contents were allowed to cool to ambient temperature. The slurry was filtered through a sintered funnel (Frit 3). The flask and cake were washed with ethyl phenyl acetate (10 mL; 1 vol). The cake only was washed with a further portion of ethyl phenyl acetate (10 mL; 1 vol). Due to the low volatility of the solvent, the product could not be isolated however the solution obtained was analyzed for appearance. The solution obtained was a dark brown clear solution.

### Example 77

To a 100 mL round bottomed flask was added spent coffee grounds (10.07 g; LR) and isoamyl acetate (50 mL; 5 vol). The slurry was agitated for 16 hr at ambient temperature and atmospheric pressure. The slurry was filtered through a sintered funnel (Frit 3). The flask and cake were washed with isoamyl acetate (10 mL; 1 vol). The cake only was washed with a further portion of isoamyl acetate (10 mL; 1 vol). The combined filtrate and washes were concentrated in vacuo at 70-75° C. Azeotropic distillation with ethyl acetate was used during the final concentration of the oil to remove residual isoamyl acetate from the product. The product isolated was a dark orange-brown oil (1.37 g; 13.6% yield).

### Example 78

To a 100 mL round bottomed flask was added spent coffee grounds (10.08 g; LR) and isoamyl acetate (50 mL; 5 vol). The slurry was agitated for 1 hr at ambient temperature and atmospheric pressure. The slurry was filtered through a sintered funnel (Frit 3). The flask and cake were washed with isoamyl acetate (10 mL; 1 vol). The cake only was washed with a further portion of isoamyl acetate (10 mL; 1 vol). The combined filtrate and washes were concentrated in vacuo at 70-75° C. Azeotropic distillation with ethyl acetate was used during the final concentration of the oil to remove residual isoamyl acetate from the product. The product isolated was a dark orange-brown oil (1.32 g; 13.1% yield).

### Comparative Example 10

To a 100 mL round bottomed flask was added spent coffee grounds (10.09 g; LR) and isoamyl acetate (50 mL; 5 vol). The slurry was agitated for 1 hr at reflux. The contents were allowed to cool to ambient temperature. The slurry was filtered through a sintered funnel (Frit 3). The flask and cake were washed with isoamyl acetate (10 mL; 1 vol). The cake only was washed with a further portion of isoamyl acetate (10 mL; 1 vol). The combined filtrate and washes were concentrated in vacuo at 70-75° C. Azeotropic distillation with ethyl acetate was used during the final concentration of the oil to remove residual isoamyl acetate from the product. The product isolated was a brown oil with dark brown/black solid precipitate present (1.32 g; 13.1% yield).

### Example 79

To a 100 mL round bottomed flask was added spent coffee grounds (10.06 g; LR) and ethyl propionate (50 mL; 5 vol). The slurry was agitated for 16 hr at ambient temperature and atmospheric pressure. The slurry was filtered through a sintered funnel (Frit 3). The flask and cake were washed with ethyl propionate (10 mL; 1 vol). The cake only was washed with a further portion of ethyl propionate (10 mL; 1 vol). The combined filtrate and washes were concentrated in vacuo at 55-60° C. The product isolated was a dark orange-brown oil (1.25 g; 12.4% yield).

### Example 80

To a 100 mL round bottomed flask was added spent coffee grounds (10.01 g; LR) and ethyl propionate (50 mL; 5 vol). The slurry was agitated for 1 hr at ambient temperature and atmospheric pressure. The slurry was filtered through a sintered funnel (Frit 3). The flask and cake were washed with ethyl propionate (10 mL; 1 vol). The cake only was washed with a further portion of ethyl propionate (10 mL; 1 vol). The combined filtrate and washes were concentrated in vacuo at 55-60° C. The product isolated was a dark orange-brown oil (1.04 g; 10.4% yield).

### Comparative Example 11

To a 100 mL round bottomed flask was added spent coffee grounds (10.04 g; LR) and ethyl propionate (50 mL; 5 vol). The slurry was agitated for 1 hr at reflux. The contents were allowed to cool to ambient temperature. The slurry was filtered through a sintered funnel (Frit 3). The flask and cake were washed with ethyl propionate (10 mL; 1 vol). The cake only was washed with a further portion of ethyl propionate (10 mL; 1 vol). The combined filtrate and washes were concentrated in vacuo at 55-60° C. The product isolated was a brown oil with dark brown/black solid precipitate present (1.26 g; 12.5% yield).

### Example 81

To a 100 mL round bottomed flask was added spent coffee grounds (10.01 g; LR) and ethyl butyrate (50 mL; 5 vol). The slurry was agitated for 16 hr at ambient temperature and atmospheric pressure. The slurry was filtered through a sintered funnel (Frit 3). The flask and cake were washed with ethyl butyrate (10 mL; 1 vol). The cake only was washed with a further portion of ethyl butyrate (10 mL; 1 vol). The combined filtrate and washes were concentrated in vacuo at 55-60° C. The product isolated was a dark orange-brown oil (1.25 g; 12.5% yield).

### Example 82

To a 100 mL round bottomed flask was added spent coffee grounds (10.02 g; LR) and ethyl butyrate (50 mL; 5 vol). The slurry was agitated for 1 hr at ambient temperature and atmospheric pressure. The slurry was filtered through a sintered funnel (Frit 3). The flask and cake were washed with ethyl butyrate (10 mL; 1 vol). The cake only was washed with a further portion of ethyl butyrate (10 mL; 1 vol). The combined filtrate and washes were concentrated in vacuo at 55-60° C. The product isolated was a dark orange-brown oil (1.15 g; 11.5% yield).

### Comparative Example 12

To a 100 mL round bottomed flask was added spent coffee grounds (10.07 g; LR) and ethyl butyrate (50 mL; 5 vol). The slurry was agitated for 1 hr at reflux. The contents were allowed to cool to ambient temperature. The slurry was filtered through a sintered funnel (Frit 3). The flask and cake were washed with ethyl butyrate (10 mL; 1 vol). The cake only was washed with a further portion of ethyl butyrate (10 mL; 1 vol). The combined filtrate and washes were concentrated in vacuo at 55-60° C. The product isolated was a brown oil with dark brown/black solid precipitate present (1.45 g; 14.4% yield).

The results of the examples 61 to 82 showed that the extraction at ambient temperature and atmospheric pressure has similar efficiency with reflux extraction. This is the case especially when the process is conducted for at least 16 hours. Furthermore, the oils obtained by extraction at ambient temperature and atmospheric pressure had improved organoleptic properties than the oils obtained by extraction at reflux.

### Impact of Extraction Temperature

Spent coffee grounds from the same batch as for experiments 61-73 were used for the following experiments.

### Example 91

To a 100 mL round bottomed flask was added ethyl acetate (50 mL; 5 vol). The solvent was heated to 50±2.5° C. To the hot solvent was added spent coffee grounds (10.05 g; LR). The slurry was agitated for 1 hr at 50±2.5° C. The slurry was allowed to cool to ambient temperature (22.8° C.). The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a dark orange-brown oil with no solid present (1.10 g; 10.9% yield).

The increase of extraction temperature from ambient to 50° C. showed only a minor improvement in terms of yield in comparison with ambient temperature. Hence, the increase of temperature does not have a significant effect on the yield as it would have been expected.

### Extraction on Unused Roasted Coffee Grounds

### Example 101

To a 100 mL round bottomed flask was added unused roasted coffee grounds (10.01 g; LR) and ethyl acetate (50 mL; 5 vol). The slurry was agitated for 16 hr at ambient temperature and atmospheric pressure. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a brown oil with brown-black precipitate (1.54 g; 15.4% yield).

### Example 102

To a 100 mL round bottomed flask was added unused roasted coffee grounds (10.08 g; LR) and ethyl acetate (50 mL; 5 vol). The slurry was agitated for 1 hr at ambient temperature and atmospheric pressure. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a brown oil with black-brown precipitate (1.32 g; 13.1% yield).

### Example 103

To a 100 mL round bottomed flask was added unused roasted coffee grounds (10.04 g; LR) and ethyl acetate (50 mL; 5 vol). The slurry was agitated for 1 hr at reflux. The contents were allowed to cool to ambient temperature. The slurry was filtered through a sintered funnel (Frit 3). The flask and cake were washed with ethyl acetate (10 mL; 1 vol). The cake only was washed with a further portion of ethyl acetate (10 mL; 1 vol). The combined filtrate and washes were concentrated in vacuo at 45-50° C. The product isolated was a brown oil with black-brown precipitate (1.53 g; 15.2% yield).

### Qualitative Analysis

Examples of analytical methods are described below in relation to Example 22. However, the same methods may be used to characterize any of the coffee oil compositions according to an embodiment of the present invention.

### Acid Value

The acid value is determined as explained in USP 43-NF38 p.6676 <401> Fixed Fats and Oils.

As data was collected for each Example, the data was trended and acceptable ranges for each value were obtained. For a data set, the number of data points and the value of each is known. From this the average was calculated according to Formula 2:

$$average = \frac{\sum data points}{number of data points} \qquad Formula 2$$

To obtain the upper and lower value for the acceptable range, the upper control limit (UCL) and lower control limit (LCL) were calculated. The formula for each is described below along with the formula used to calculate the standard deviation (Formula 3):

$$\begin{matrix}upper control limit - average + ( 3 \times standard deviation of all data points ) \\ lower control limit = average - ( 3 \times standard deviation of all data points ) \\ standard deviation = \sqrt{\frac{\sum {( xi - μ )}^{2}}{N}}\end{matrix} \qquad Formula 3$$

where
xi=each value from the dataset
μ=the average of the dataset
N=the number of data points in the dataset

The following data presented in Table 4 were obtained for Example 22:

TABLE 3
Example dataset for acid value.

| Measurement | Dataset |
|---|---|
| 1 | 1.89 |
| 2 | 1.32 |
| 3 | 0.73 |
| 4 | 1.90 |
| 5 | 2.10 |

$$\begin{matrix}average = \frac{1.89 + 1.32 + 0.73 + 1.9 + 2.1}{5} = 1.588 \\ standard deviation = \sqrt{\frac{{( 1.89 - 1.588 )}^{2} + {( 1.32 + 1.588 )}^{2} + {( 0.73 + 1.588 )}^{2} + {( 1.9 - 1.588 )}^{2} + {( 2.1 + 1.588 )}^{2}}{5}} = 0.56 \\ upper control limit = 1.588 + ( 3 \times 0.56 ) = 3.27 \\ lower control limit = 1.588 - ( 3 \times 0.56 ) = - 0.09\end{matrix}$$

The numbers are rounded such as to encompass the UCL and LCL calculated. For this dataset the ranges were rounded to the nearest mg. The acid values calculated for the extracted coffee oils were of 4 mg/g or below.

### Density

Masses were recorded on a OHAUS Navigator™ NV422 balance. Volumes were measured using an Eppendorf single channel pipette (1-10 mL).

1 mL of coffee oil from Example 22 was measured accurately and weighed (0.97 g). The density was calculated using Formula 4:

$$ρ = \frac{m}{V} , \qquad Formula 4$$

where:
ρ=density of sample (g/mL)
m=exact mass of sample taken (g)
V=total volume of sample weighed (mL)

Example calculation for coffee oil using Formula 4:

$$ρ = \frac{0.97}{1.} = 0.97 g / mL$$

### SAP Value

The SAP value is determined as explained in USP 43-NF38 p.6676 <401> Fixed Fats and Oils. Potassium hydroxide pellets (≥85%) were sourced from Scientific Laboratory Supplies. Methanol (99%) was sourced from Alfa Aesar. Phenolphthalein solution (indicator; Reag. Ph. Eur.; 1% in ethanol) and 0.5 N hydrochloric acid (Volumetric; Reag. Ph. Eur.; 0.5M; 0.5N) were sourced from Honeywell Fluka. Masses were recorded on a OHAUS Navigator™ NV422 balance. The volumetric glassware used was Class A analytical grade. Smaller volumes were measured using an Eppendorf single channel pipette (1-10 mL).

The procedure was as follows: 1.49 g of coffee oil from Example 22 was weighed into a 500 mL round bottomed flask. To this was added 25 ml of 0.5 N alcoholic potassium hydroxide. The contents were refluxed for 90 mins. The contents were allowed to cool. To this was added 1 mL of phenolphthalein TS. The solution was titrated with 0.25 N hydrochloric acid VS until the pink color was removed and the initial color was observed. The volume of 0.25 N hydrochloric acid VS required was 21.8 mL. A blank titration was conducted on 25 mL of 0.5 N potassium hydroxide solution with 1 mL of phenolphthalein. The blank titer was 45.0 mL.

The saponification value was calculated as per Formula 5:

$$SAP Value = \frac{Mr \times ( VB - VT ) \times N}{W} \qquad Formula 5$$

where,
Mr=molecular weight of potassium hydroxide (56.11)
VB=volume of hydrochloric acid consumed in the blank test (mL)
VT=Volume of hydrochloric acid consumed in the actual test (mL)
N=Exact normality of the hydrochloric acid solution
W=weight of the substance taken for the test

For Example 22, the SAP Value according to Formula 5 is:

$$SAP Value = \frac{56.11 \times ( 45. - 21.8 ) \times 0.25}{1.49} = 218.41$$

### Free Fatty Acid Value

The Free fatty acid value is determined as explained in USP 43-NF38 p.6676 <401> Fixed Fats and Oils. Methanol (HPLC grade, 99.9%) and 1 N potassium hydroxide solution were supplied by Fisher, diethyl ether (puriss, >99.5%) was supplied by Honeywell. The volumetric glassware used was Class A analytical grade. Masses were recorded on a OHAUS Navigator™ NV422 balance. The procedure is as follows:

1.02 g of coffee oil from Example 22 was dissolved in 50 ml of a 1:1 mixture of diethyl ether and methanol. This mixture was titrated vs 0.01 N potassium hydroxide solution until a precipitate formed which persisted for at least 30 seconds (titer=1.8 mL potassium hydroxide, 0.01N).

The titer of 0.01N potassium hydroxide can be used to determine the free fatty acid (FFA) value for the sample using Formula 6:

$$FFA = ( Mr \times V ) \times ( N / W ) , \qquad Formula 6$$

where
Mr=molecular weight of potassium hydroxide (56.11 g/mol⁻¹)
V=titer of 0.01 N potassium hydroxide used in titration (mL)
N=exact normality of the potassium hydroxide solution used (N)
W=weight of sample used in titration (g)

The following calculation is applicable to Example 22:

$$FFA = ( 56.11 \times 1.8 ) \times ( 0.01 / 1.02 )$$

$$FFA = 0.99 mg / g$$

### Iodine Value

The lodine value is determined as explained in USP 43-NF38 p.6676 <401> Fixed Fats and Oils. lodine monobromide (98%), potassium iodide (99%) and starch indicator solution (1%, Acculute Standard Volumetric Solution) were supplied by Alfa Aesar, acetic acid, glacial acetic acid (99%) was supplied by Fisher, 0.1N sodium thiosulfate solution was supplied by Honeywell. The volumetric glassware used was Class A analytical grade. Smaller volumes were measured using an Eppendorf single channel pipette (1-10 mL). Masses were recorded on a OHAUS Navigator™ NV422 balance. The procedure is as follows:

lodobromide Test Solution (TS)—2.03 g of iodobromide was dissolved in 100 ml of glacial acetic acid and stored in a glass container protected from light. Potassium lodide Test Solution (TS)—16.49 g of potassium iodide was dissolved in 100 ml of deionized water and stored in a glass container protected from light.

Sample Titration: 0.20 g of coffee oil from Example 22 was dissolved in 25 ml of dichloromethane. To this was added 25 mL of iodobromide TS. The solution was allowed to stand, protected from light for 30 minutes, mixing every 10 minutes. To this, was added 30 mL of potassium iodide TS and 100 ml of deionized water. The solution was titrated VS 0.1N sodium thiosulfate solution until the iodine color became pale and at this point, 3 ml of starch indicator solution was added. The titration VS 0.1N sodium thiosulfate was resumed until the iodine color in the aqueous phase was discharged completely. The titer was recorded as 36.8 mL.

Blank Titration: 25 mL of dichloromethane was added to a vessel and to this was added 25 mL of iodobromide TS. The solution was allowed to stand, protected from light for 30minutes, mixing every 10 minutes. To this was added 30 mL of potassium iodide TS and 100 mL of deionized water. The solution was titrated VS 0.1N sodium thiosulfate solution until the iodine color became pale. At this point, 3 ml of starch indicator solution was added. The titration VS 0.1N sodium thiosulfate was resumed until the iodine color in the aqueous phase was discharged completely. The titer was recorded as 46.4 mL.

The sample titer and the blank titer can be used to calculate the iodine value, describing the degree of unsaturation in the oil, using Formula 7:

$$Iodine value = \frac{[ Ar \times ( VB - Vs ) - N ]}{10 \times W} , \qquad Formula 7$$

where
Ar=atomic weight of iodine (126.90)
VB=volume of 0.1N sodium thiosulfate VS consumed by the blank (mL)
VS=volume of 0.1N sodium thiosulfate VS consumed by the sample (mL)
N=exact normality of the sodium thiosulfate solution (N)
W=mass of the sample taken (g)

The following calculation is applicable to Example 22:

$$Iodine value = [ 126.9 \times ( 46.4 - 36.8 ) \times 0.1 ] / ( 10 \times 0.2 )$$

$$Iodine value = 60.9 g {I}_{2} / 100 g$$

### Tocopherol Content

All UV-Visible spectrophotometry measurements were conducted on a Jenway 7205 Spectrophotometer.

α-tocopherol (95%; synthetic) was obtained from ACROS Organics. Isopropanol was obtained from ReAgent. Masses were recorded on a OHAUS Navigator™ NV422 balance. The volumetric glassware used was Class A analytical grade. Smaller volumes were measured using an Eppendorf single channel pipette (1-10 mL).

Tocopherol Standard Solutions: 0.10 g of α-tocopherol was weighed into a 100 ml volumetric flask. This was diluted to volume with isopropanol. The mixture was shaken until full dissolution of α-tocopherol was observed. This solution (A—1000 μg/mL) was used to make up a further 11 standard solutions ranging from 1-100 μg/mL (B-L).

Sample solutions: 0.97 g of sample taken from Example 22 was weighed into a vial. To this was added 10 mL of isopropanol. This solution (sample solution 1) was shaken until full dissolution of the sample was achieved. To a 100 mL volumetric flask was added 1 mL of sample solution 1. This was diluted to volume with isopropanol and shaken until fully mixed (sample solution 2). To a 100 mL volumetric flask was added 1 mL of sample solution 2. This was diluted to volume with isopropanol and shaken until fully mixed (sample solution 3).

UV-Vis analysis: Sample solutions A-L according to Table 4 were analyzed by UV-Vis at 290 nm. The blank, consisting of isopropanol only, was also analyzed at 290 nm. A calibration curve was obtained from the standard solutions. Any values within the range 2.0-2.50 for absorbance were discarded and these saturated the detector. The linear line of the best fit for the graph was fitted and the equation was used to calculate the tocopherol content in the sample. All sample solutions were analyzed by UV-Vis. The value which resided most central in the data points obtained from the standard solutions was used for the calculation of tocopherol. Any obvious outliers to the linear line of best fit for the standards were removed from the graph provided at least 8 data points remain on the graph. The equation from the line of best fit is presented in Formula 8:

$$y = mx + C \qquad Formula 8$$

where
y=absorbance
x=concentration (μg/mL)
m=gradient
C=y-intercept

Therefore, for a-tocopherol concentration in the diluted sample measured by UV-Vis is according to Formula 9:

$$x = \frac{y - C}{m} \qquad Formula 9$$

The value for α-tocopherol/gram of coffee oil can be calculated from the concentration calculation above and the mass of coffee oil in the original sample.

The following calculation is applicable to Example 22:

TABLE 4
Example of absorbances recorded for standard
solutions A-L for α-tocopherol

| | Concentration | Concentration of α- | |
|---|---|---|---|
| Standard | by mass | tocopherol | Absorbance at |
| solution | (μg/mL) | (95%; μg/mL) | 290 nm |
| A | 1000 | 950.00 | 2.500 |
| B | 100 | 95.00 | 0.746 |
| C | 90 | 85.50 | 0.660 |
| D | 80 | 76.00 | 0.541 |
| E | 70 | 66.50 | 0.494 |
| F | 60 | 57.00 | 0.430 |
| G | 50 | 47.50 | 0.400 |
| H | 40 | 38.00 | 0.393 |
| I | 30 | 28.50 | 0.245 |
| J | 20 | 19.00 | 0.146 |
| K | 10 | 9.50 | 0.165 |
| L | 1 | 0.95 | −0.004 |

FIG. 2 shows the calibration curve obtained from standard solutions of α-tocopherol. The equation obtained for the line of best fit is as follows:

$$y = 0.00759 x + 0.00483$$

The absorbance of sample solution 3 was 0.423. The quantity of α-tocopherol in the sample can be calculated as follows:

$$x = \frac{y - 0.00483}{0.00759} = \frac{0.423 - 0.00483}{0.00759} = 55.095 μg / mL in sample solution 3$$

$$Concentration of α - tocopherol in sample solution 1 = 5.5095 mg / mL$$

$$α - tocopherol content in oil = \frac{5.5095}{0.97} = 5.68 mg of α - tocopherol / gram of coffee oil$$

### Peroxide Value

All UV-Visible spectrophotometry measurements were conducted on a Jenway 7205 Spectrophotometer. Hydrogen peroxide (30% in water) was obtained from Fisher, Pierce™ Quantitative Peroxide Assay: Lipid Compatible Formulation was obtained from Thermo Scientific.

Working reagent preparation—100 μL of Reagent A (Pierce™ Quantitative Peroxide Assay: Lipid Compatible Formulation) was added to 10 ml of Reagent C (Pierce™ Quantitative Peroxide Assay: Lipid Compatible Formulation).

A 30% (9.8M) stock solution of hydrogen peroxide was serially diluted to obtain 7 standard solutions in the range of 10-100 μM.

90 μL of each standard solution was added to 900 μL of working reagent followed by 10 μL of methanol and each solution was left for 20 minutes before the absorbance of each solution was measured at 560 nm and a calibration curve was constructed.

90 μL of coffee oil from Example 22 was added to 900 μL of working reagent followed by 10 μL of methanol. The solution was left to stand for 20 minutes before the absorbance was measured at 560 nm. The absorbance value for the sample was compared to the calibration curve to calculate the peroxide value for the coffee oil.

Sample solutions 1-7 were analyzed by UV-Vis at 560 nm. The blank, consisting of water and working reagent only, was also analyzed at 560 nm. A calibration curve was obtained from the standard solutions. Any values within the range 2.0-2.50 for absorbance were discarded and these saturated the detector. The linear line of the best fit for the graph was fitted and the equation was used to calculate the peroxide value for the sample. All sample solutions were analyzed by UV-Vis. The value which resided most central in the data points obtained from the standard solutions was used for the calculation of the peroxide value. The equation from the line of best fit is as follows according to Formula 10:

$$y = mx + C \qquad Formula 10$$

where
y=absorbance
x=concentration (μg/mL)
m=gradient
C=y-intercept

Therefore, for peroxide value of the sample measured by UV-Vis is calculated with Formula 11:

$$x = \frac{y - C}{m} \qquad Formula 11$$

The value for mmol of coffee oil can be calculated from the concentration calculation. The peroxide value is defined as the amount of peroxide oxygen per 1 kilogram of fat or oil, expressed in units of milliequivalents. (N.B. 1 milliequivalents=0.5 millimole; as 1 mEq of O2=1 mmol/2=0.5 mmol of O2, where 2 is valence)

The following calculation is applicable to Example 22:

TABLE 5
Example of calibration curve data for calculation of peroxide value:

| Standard | [H2O2] | Absorbance at |
|---|---|---|
| Solution | (μM) | 560 nm |
| 1 | 10 | 0.019 |
| 2 | 20 | 0.075 |
| 3 | 30 | 0.133 |
| 4 | 40 | 0.238 |
| 5 | 50 | 0.4 |
| 6 | 75 | 0.71 |
| 7 | 100 | 0.94 |

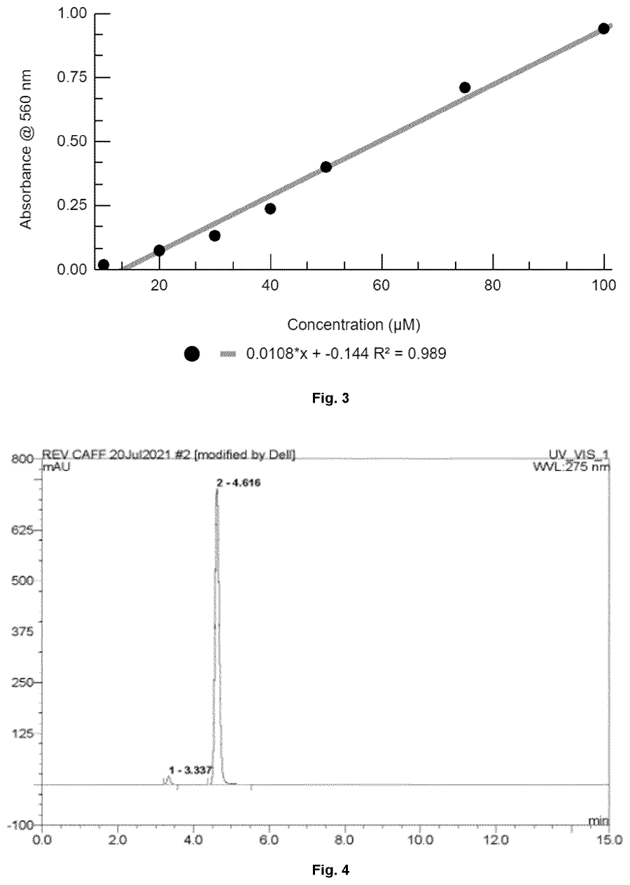

FIG. 3 shows the calibration curve obtained from the data of Table 5 for the calculation of the peroxide value. The equation obtained for the line of best fit is as follows:

y=0.0108x+−0.144

The absorbance for the sample of coffee oil was 0.754, the concentration of peroxide value was calculated as follows:

$$X = ( y + 0.144 ) / 0.0108 = ( 0.754 + 0.144 ) / 0.0108 = 83 μM = ( 83 / 1000 ) \times 2 \times 0.97 = 0.161 {mEqO}_{2} / kg$$

### Caffeine Content

The caffeine content is determined by HPLC chromatography as explained in USP29-NF24 Page 338.

Tetrahydrofuran (HPLC grade, 99.8%), acetonitrile (HPLC grade, 99.8%) and glacial acetic acid (99%) were supplied by Fisher Scientific. Caffeine (99.7%) and anhydrous sodium acetate (99%) were supplied by Alfa Aesar. Theophylline (99+%) was supplied by Acros Organics.

The procedure is as follows—

In the mobile phase preparation, 1.64 g of anhydrous sodium acetate was dissolved in 2 L of deionized water. The solution was filtered through a 0.2 micron filter. 1910 ml of this solution was taken and transferred to a separate vessel. To this was added 50 mL acetonitrile and 40 mL of tetrahydrofuran. The solution was mixed carefully and the pH was adjusted to approximately 4.5 using glacial acetic acid.

For the system suitability preparation solution 1-0.10 g of theophylline was measured into a 100 mL volumetric flask. To this was added approximately 80 mL of mobile phase and the solution was heated to 45° C. until all solids were fully dissolved. The solution was diluted with mobile phase to volume and shaken to mix.

For the system suitability preparation solution 2-2 mL of system suitability solution 1 was measured accurately into a 100 mL volumetric flask. The solution was diluted with mobile phase to volume and shaken to mix.

For the standard preparation solution 3-0.10 g of caffeine was measured accurately into a 100 mL volumetric flask and approx. 50 mL of mobile phase was added. The solution was shaken until the solids had completely dissolved. The solution was diluted with mobile phase to volume. The mixture was shaken to combine.

For the standard preparation solution 4-20 ml of Standard Solution 3 was measured into a 100 mL volumetric flask and to this was added 20 ml of System Suitability Solution 2 and 20 mL of mobile phase. The mixture was shaken to combine and the mobile phase was added to volume.

Sample preparation—0.2 g of coffee oil of Example 22 was weighed out and diluted with 10 ml of mobile phase. The solution was left to stir overnight. The sample was passed through a 0.22 μm filter before injection.

The HPLC assay was performed and analyzed by a high performance liquid chromatograph (HPLC; Agilent 1100) equipped with a diode array detector (G1315B Diode Array Detector). A BDS Hypersil 5 μm-C₁₈ column (Thermo, 4.6 mm×150 mm) was employed at 25° C. The injection volume was 10 μL. The compounds were eluted on an isocratic mobile phase consisting of 10 mM sodium acetate buffer pH 4.5/acetonitrile/tetrahydrofuran (955:25:20 v/v/v). The separated compounds were monitored at 275 nm and the flow rate was set to 1 mL/min.

Standard solution 4 and sample were chromatographed and the peak responses were recorded. The relative retention times for caffeine and theophylline were 1.0 and 0.70 respectively adhering to the USP specifications for a caffeine assay as explained in USP29-NF24, p.338.

The following calculation is applicable to Example 22:

FIG. 4 shows the HPLC chromatogram of the Standard Solution 4, having two peak responses as presented in Table 6.

TABLE 6
Example of HPLC data of the Standard Solution 4

| | Retention time | | Height |
|---|---|---|---|
| # | (min) | Peak name | (mAU) |
| 1 | 3.337 | Theophylline | 20.743 |
| 2 | 4.616 | Caffeine | 727.476 |

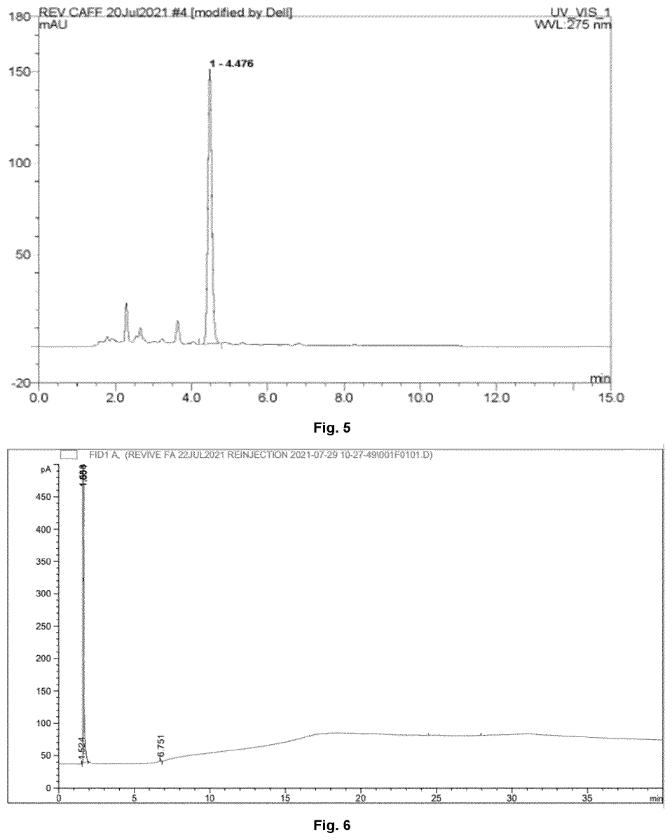

FIG. 5 shows the HPLC chromatogram of the coffee oil sample for determination of the caffeine content, having one peak response corresponding to caffeine as presented in Table 7:

TABLE 7
Example of HPLC data of the coffee oil sample

| | Retention time | | Height |
|---|---|---|---|
| # | (min) | Peak name | (mAU) |
| 1 | 4.476 | Caffeine (sample) | 151.026 |

As directed from the US Pharmacopoeia monograph (USP29-NF24 Page 338) the relative retention times for caffeine and theophylline should be approximately 1.0 and 0.69 respectively. To calculate relative retention time of a peak X vs peak Y Formula 12 applies:

$$RRT ( X ) = RT ( X ) / RT ( Y ) , \qquad Formula 12$$

where:
RRT(X) is the relative retention time of peak X vs the peak Y.
RT(X) is the retention time of peak X.
RT(Y) is the retention time of peak Y.

For this specific example:

$$RRT ( 1 ) = 3.337 / 4.616$$

$$RRT ( 1 ) = 0.72$$

Using the peak responses for the caffeine in Standard solution 4 and Assay, the quantity in mg of C₈H₁₀N₄O₂ in the assay sample can be calculated using the Formula 13:

$$mass = 50 C ( {r}_{u} / {r}_{s} ) , \qquad Formula 13$$

where:
   Mass=mass of caffeine in the sample in mg
   C=the concentration of caffeine in mg per ml in Standard solution 4.
   rᵤ and rₛ are the peak responses for caffeine obtained from the sample preparation and the standard solution 4 preparation respectively.

Example calculation:

$$Mass = 50 \times 0.2 \times ( 151.026 / 727.476 )$$

$$Mass = 2.08 mg per 200 mg$$

$$Mass = 1.04 mg per 100 mg$$

### Fatty Acid Composition in Coffee Oil

The fatty acid composition in the coffee oil is determined by gas chromatography (GC) as explained in US Pharmacopeia, USP 43-NF38 p.6676 <401> Fixed Fats and Oils. The following method and calculation is applicable to Example 22.

Reagents: Potassium hydroxide pellets (≥85%) were obtained from Scientific Laboratory

Supplies. Methanol (99%) was obtained from Alfa Aesar. Methanolic boron trifluoride (12%; 1.5 M) and n-heptane (HPLC grade; 99%) were obtained from ACROS Organics. Sodium sulphate (anhydrous; 99%) was obtained from Alfa Aesar. Methyl linoleate (99%) was obtained from ACROS Organics. Fatty acid methyl ester mix (USP reference standard; FAME standard mix; 100 mg; 25 FAME's) was obtained from Scientific Laboratory supplies. The gas chromatography system used was the G1530A Agilent 6890 GC. The GC column was purchased from Agilent (DB-Wax; Part No. 122-7032; 30 m×0.25 mm; 0.25 μm; 7 inch; fused silica). The GC method was based on Agilent Technologies; Column Selection for the Analysis of Fatty Acid Methyl Esters; Application; Food Analysis; Page 4-5; Method 1.

Standard solutions: 100 mg of methyl linoleate was dissolved in 10 mL of n-heptane (10 mg/mL). A 1 mg/mL solution of methyl linoleate was made up by diluting 1 mL of methyl linoleate 10 mg/mL solution with 9 mL of n-heptane. Both the reference standard mix and the 1 mg/ml methyl linoleate standard used as marker was analyzed by gas chromatography. Other standard solutions of methyl palmitate, methyl stearate, methyl oleate, methyl linolenate, methyl arachidate and methyl behenate were made up in the same way and analyzed by gas chromatography to provide markers for retention times. Sample digestion: 0.1 g of sample of coffee oil according to Example 22 was weighed into a round bottomed flask. To this was added 2 mL of 20 g/L methanolic potassium hydroxide. The contents were refluxed for 30 minutes. To this was added 2 ml of methanolic boron trifluoride solution through the condenser. The contents were refluxed for 30 minutes. To this was added 4 mL of n-heptane through the condenser. The contents were refluxed for 5 minutes. The contents were allowed to cool for 30-60 minutes. To the cooled mixture was added 15 mL of saturated sodium chloride solution. The mixture was transferred to a separating funnel. The aqueous phase was discarded. The organic phase was washed with 10 ml of deionized water. The aqueous phase was discarded. The organic phase was dried over anhydrous sodium sulphate. The dried organic phase filtered through a cotton wool plugged pipette. The resulting solution was analyzed by gas chromatography. Details of the instrumentation and of the experimental conditions are provided below in Table 8.

TABLE 8
Gas chromatographic method for analysis of fatty acid composition
Instrumentation

| | |
|---|---|
| Chromatographic | G1530A Agilent 6890 GC |
| system | |
| Inlet temperature | split |
| Detector | FID |
| Automatic sampler | Agilent 7683A Autoinjector |
| Liner | 5183-4711 split liner, single taper with glass wool |
| Column | Agilent; DB-Wax; Part No. 122-7032; 30 m × |
| | 0.25 mm; 0.25 μm; 7 inch; fused silica |

Experimental conditions GC-FID

| | |
|---|---|
| inlet temperature | 250° C. |
| injection volume | 1 μL |
| split ratio | 1/50 |
| carrier gas | hydrogen |
| oven temperature | hold at 50° C. for 1 minute |
| | 25° C./minute to 200° C. |
| | 3° C./minute to 230° C. |
| | hold at 230° C. for 23 minutes |
| detector | 280° C. |
| temperature | |
| detector gases | Hydrogen: 40 mL/minute |
| | Air: 450 mL/minute |
| | Nitrogen (make-up gas): 30 mL/minute |

Peak areas for all fatty acid ester signals are integrated. The peak areas can then be used to calculate the peak area % of each signal. Any signal with a % peak area <0.05% after all signals are integrated is removed. Each signal is identified by comparing the retention time with the retention times observed in the standard fatty acid ester mix. The Formula 14 is used to calculate the peak area % as follows:

$$Peak area \% = 100 \times \frac{A}{B} \qquad Formula 14$$

where
A=the peak area response obtained for each signal
B=the sum of the peak areas of all signals integrated in the chromatogram minus the solvent signal

The results for the current example are presented in Table 12.

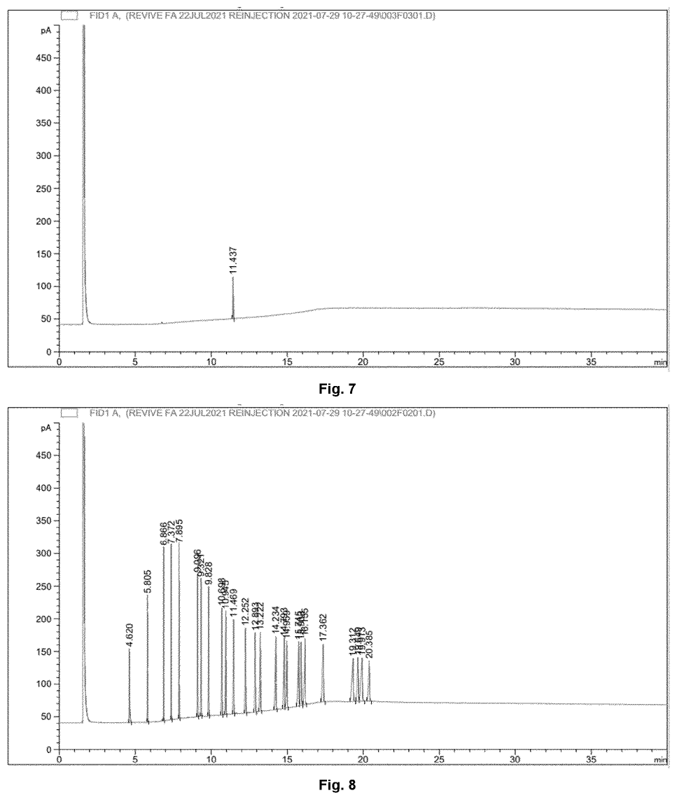

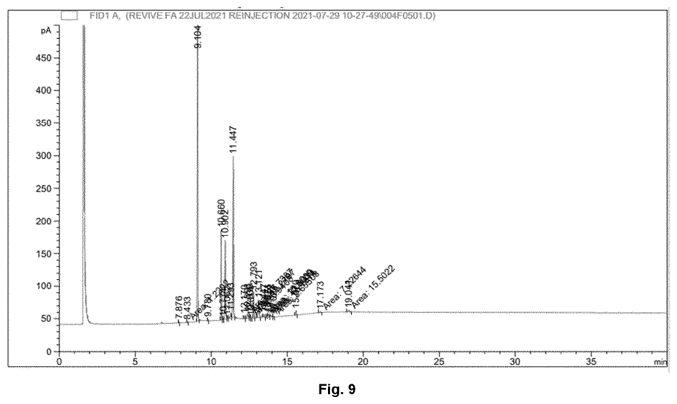

According to the present Example, the following GC chromatograms and data were obtained:
the GC chromatogram of the blank sample is presented in FIG. 6 while the corresponding data are shown below in Table 9
the GC chromatogram of the methyl linoleate marker is presented in FIG. 7 while the corresponding data are shown below in Table 10
the GC chromatogram of the reference standard mix is presented in FIG. 8 while the corresponding data are shown below in Table 11; and
the GC chromatogram of the sample of coffee oil is presented in FIG. 9 while the corresponding data and peak area calculation are shown below in Table 12.

TABLE 9
GC data of the blank sample

| | | Retention | | Area |
|---|---|---|---|---|
| | | Time | | Percent |
| Signal | ID | (mins) | Area | (%) |
| 1 | Solvent Signal | 1.524 | 1.79904 | 0.00079 |
| 2 | Solvent Signal | 1.588 | 225819 | 99.53253 |
| 3 | Solvent Signal | 1.651 | 1047.44910 | 0.46168 |
| 4 | Unknown in Blank | 6.751 | 11.34250 | 0.00500 |

TABLE 10
GC data of methyl linoleate marker

| | | Retention | | Area |
|---|---|---|---|---|
| | | Time | | Percent |
| Signal | ID | (mins) | Area | (%) |
| 1 | Methyl linoleate | 11.437 | 163.85565 | 100.0000 |

TABLE 11
GC data of fatty acid methyl ester USP reference standard mix

| | | Carbon | Retention | | Area |
|---|---|---|---|---|---|
| | | Chain:Double | Time | | Percent |
| Signal | ID | bonds | (mins) | Area | (%) |
| 1 | methyl octanoate | (C8:0) | 4.620 | 281.55551 | 2.80943 |
| 2 | methyl decanoate | (C10:0) | 5.805 | 308.99533 | 3.08323 |
| 3 | methyl laurate | (C12:0) | 6.866 | 352.74579 | 3.51978 |
| 4 | methyl tridecanoate | (C13:0) | 7.372 | 376.24539 | 3.75426 |
| 5 | methyl myristate | (C14:0) | 7.895 | 394.95090 | 3.94091 |
| 6 | methyl palmitate | (C16:0) | 9.096 | 408.90738 | 4.08017 |
| 7 | methyl palmitoleate | (C16:1) | 9.321 | 399.35797 | 3.98489 |
| 8 | methyl heptadecanoate | (C17:0) | 9.828 | 413.21555 | 4.12316 |
| 9 | methyl stearate | (C18:0) | 10.698 | 420.23907 | 4.19324 |
| 10 | methyl oleate | (C18:1) | 10.945 | 415.65842 | 4.14753 |
| 11 | methyl linoleate | (C18:2) | 11.469 | 402.34018 | 4.01464 |
| 12 | methyl linolenate | (C18:3) | 12.252 | 390.97531 | 3.90124 |
| 13 | methyl arachidate | (C20:0) | 12.893 | 431.47592 | 4.30537 |
| 14 | methyl 11-eicosenoate | (C20:1) | 13.222 | 421.87857 | 4.20960 |
| 15 | methyl heneicosanoate | (C21:0) | 14.234 | 427.09695 | 4.26167 |
| 16 | methyl arachidonate | (C20:4) | 14.793 | 397.35229 | 3.96487 |
| 17 | methyl 11-14-17- | (C20:3) | 14.959 | 412.80328 | 4.11905 |
| | eicosatrienoate | | | | |
| 18 | methyl | (C20:5) | 15.745 | 439.45471 | 4.38498 |
| | eicosapentanoate | | | | |
| 19 | methyl behenate | (C22:0) | 15.903 | 396.67181 | 3.95808 |
| 20 | methyl erucate | (C22:1) | 16.155 | 440.82648 | 4.39867 |
| 21 | methyl tricosanoate | (C23:0) | 17.362 | 449.29852 | 4.48320 |
| 22 | methyl | (C22:5) | 19.312 | 441.08109 | 4.40121 |
| | docosapentanoate | | | | |
| 23 | methyl lignocerate | (C24:0) | 19.649 | 380.24725 | 3.79419 |
| 24 | methyl | (C22:6) | 19.913 | 446.53760 | 4.45565 |
| | docosahexaenoate | | | | |
| 25 | methyl nervonate | (C24:1) | 20.385 | 371.90759 | 3.71098 |

TABLE 12
GC Data of sample

| | | Carbon | Retention | | Area |
|---|---|---|---|---|---|
| | | Chain:Double | Time | | Percent |
| Signal | ID | bonds | (mins) | Area | (%) |
| 1 | methyl myristate | (C14:0) | 7.876 | 2.55811 | 0.07 |
| 2 | methyl palmitate | (C16:0) | 9.104 | 1521.42688 | 43.17 |
| 3 | methyl heptadecanoate | (C17:0) | 9.780 | 4.57379 | 0.13 |
| 4 | methyl stearate | (C18:0) | 10.660 | 344.80582 | 9.78 |
| 5 | likely C18 unsaturated | NA | 10.774 | 4.07067 | 0.12 |
| | isomers | | | | |
| 6 | methyl oleate | (C18:1) | 10.902 | 381.62283 | 10.82 |
| 7 | likely C18 unsaturated | NA | 11.062 | 7.39764 | 0.21 |
| | isomers | | | | |
| 8 | likely C18 unsaturated | NA | 11.293 | 32.59197 | 0.92 |
| | isomers | | | | |
| 9 | methyl linoleate | (C18:2) | 11.447 | 785.02521 | 22.23 |
| 10 | methyl linolenate | (C18:3) | 12.170 | 13.19685 | 0.37 |
| 11 | likely C18 unsaturated | NA | 12.393 | 37.73874 | 1.07 |
| | isomers | | | | |
| 12 | likely C18 unsaturated | NA | 12.536 | 18.27970 | 0.52 |
| | isomers | | | | |
| 13 | likely C18 unsaturated | NA | 12.614 | 3.94080 | 0.11 |
| | isomers | | | | |
| 14 | methyl arachidate | (C20:0) | 12.793 | 121.22068 | 3.44 |
| 15 | methyl 11-eicosenoate | (C20:1) | 13.121 | 118.95795 | 3.38 |
| 16 | likely C20 unsaturated | NA | 13.447 | 21.42357 | 0.62 |
| | isomers | | | | |
| 17 | likely C20 unsaturated | NA | 13.671 | 15.80890 | 0.45 |
| | isomers | | | | |
| 18 | likely C20 unsaturated | NA | 13.755 | 23.80394 | 0.68 |
| | isomers | | | | |
| 19 | likely C20 unsaturated | NA | 13.912 | 15.18144 | 0.43 |
| | isomers | | | | |
| 20 | methyl heneicosanoate | (C21:0) | 14.094 | 2.65508 | 0.08 |
| 21 | methyl | (C20:5) | 15.570 | 24.40250 | 0.69 |
| | eicosapentanoate | | | | |
| 22 | methyl tricosanoate | (C23:0) | 17.173 | 7.22644 | 0.21 |
| 23 | methyl | (C22:5) | 19.312 | 441.08109 | 4.40 |
| | docosapentanoate | | | | |

1. A method of extracting coffee oil from a coffee-based feedstock, the method comprising:
extracting the coffee oil using an extraction solvent, wherein a mixture of the coffee-based feedstock and the extraction solvent is kept under mechanical or magnetic agitation for at least 30 minutes; and
subsequently separating a liquid phase comprising the extraction solvent and removing the extraction solvent from the liquid phase, to obtain the coffee oil,
wherein the extraction solvent is an ester solvent represented by formula (I) 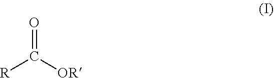
wherein R and R′ represent, independently, a substituted or unsubstituted aliphatic or aromatic group.

2. The method according to claim 1, wherein the method is conducted at a temperature between 15 and 25° C.

3. The method according to claim 1, wherein the method is conducted for at least 30 minutes.

4. The method according to claim 1, wherein the method is conducted at atmospheric pressure.

5. The method according to claim 1, wherein the method is conducted in a standard oxygen rich or inert atmosphere.

6. The method according to claim 1, wherein in formula (I), R is an aliphatic group with 1 to 12 carbon atoms or 1 to 6 carbon atoms.

7. The method according to claim 6, wherein in formula (I), R is a straight or branched chain C1-C4 alkyl group.

8. The method according to claim 1, wherein in formula (I), R′is a straight or branched chain alkyl group.

9. The method according to claim 8, wherein the compound with formula (I) is ethyl acetate.

10. The method according to claim 1, wherein the coffee-based feedstock is selected from the group consisting of: roast coffee beans and coffee spent grounds.

11. The method according to claim 1, wherein the coffee oil further undergoes a process of purification comprising:
dissolving the obtained coffee oil in a purification solvent, adding activated charcoal, and maintaining under mechanical or magnetic agitation for at least three hours, to obtain a slurry;
filtering the obtained slurry to separate the liquid phase containing the coffee oil;
removing the purification solvent from the liquid phase, to isolate purified coffee oil.

12. The process according to claim 11, wherein the purification solvent is heptane.

13. The process according to claim 10, wherein the method further comprises a purification process, the purification process comprising:
filtering the obtained slurry to separate the liquid phase containing coffee oil and removing the purification solvent, to isolate purified coffee oil.

14. A coffee oil comprising:
triglycerides, fatty acids, sterols, melanoidins and phospholipids,
wherein a composition of the fatty acids and the triglycerides is:
palmitic acid at 21-87 peak area %,
stearic acid at 4-21% peak area %,
oleic acid at 4-15% peak area %,
linoleic acid at ≤50% peak area %,
linolenic acid at ≤2% peak area %,
arachidic acid at 1-8% peak area %, and
behenic acid at ≤3% peak area %.

15. A coffee oil made according to the method of claim 9, the coffee oil having:
an acid value of 4 mg KOH/g oil or less;
an iodine value of between 13-138 g/100 g;
a SAP value between 132 and 192;
a peroxide value of 5 mEq oxygen/g or less;
a caffeine content of 1.5 wt % based on the total weight of the coffee oil or less;
a tocopherol content of 2 wt % based on the total weight of the coffee oil or less; and
a density between 0-1 g/mL.

16. The method according to claim 3, wherein the method is conducted for at least one hour.

17. The method according to claim 16, wherein the method is conducted for at least 16 hours.

18. The method according to claim 11, wherein the removing is performed in vacuo.

19. The method according to claim 13, wherein the filtering is performed in vacuo.
